(19) United States
(12) Patent Application Publication
(10) Pub. No.: US 2003/0021946 A1
(43) Pub. Date: Jan. 30, 2003

(54) Soft foam textile composite

(76) Inventors: Sterling R. Mensch III, Greer, SC (US); Yoshiharu Nakashima, Spartanburg, SC (US); Leigh Anne Hensley, Greenville, SC (US); Jason Snipes, Inman, SC (US)

Correspondence Address: Milliken & Company, P. O. Box 1927, Spartanburg, SC, 29304, US

(21) Appl. No.: 09/918,314

(22) Filed: Jul. 30, 2001

(51) Int. Cl. B32B 3/02; B32B 5/18; D04H 11/00; D03D 27/00; B32B 9/00

(52) U.S. Cl. 428/95; 442/370; 442/221; 442/315; 428/91; 428/318.4

(57) ABSTRACT

A textile is coated with a backing coating, and a foam backing is applied to the backing coating surface of the textile. A backing material is mounted to the surface of the foam backing opposite to the textile.

### BACKGROUND

The present invention generally relates to textile and foam composites, and in particular, to laminations of textiles with a soft foam for use in areas such as automotive upholstery.

Various upholstery applications, such as automotive upholstery, apply a textile material to a cushion bun. In some instances, a foam material is laminated to the textile on the side of the textile which engages the bun. However, the laminated foam textile will lift from the bun adjacent to corners of the bun, creating an untailored appearance. Therefore, there is a need for foam laminated materials which can pass over sharp corners of buns, such as automotive seating buns, without creating a gap between the foam and the bun.

### BRIEF DESCRIPTION OF THE DRAWINGS

FIG. 1 is an enlarged cross sectional view of an embodiment of the present invention illustrated as a foam textile lamination.

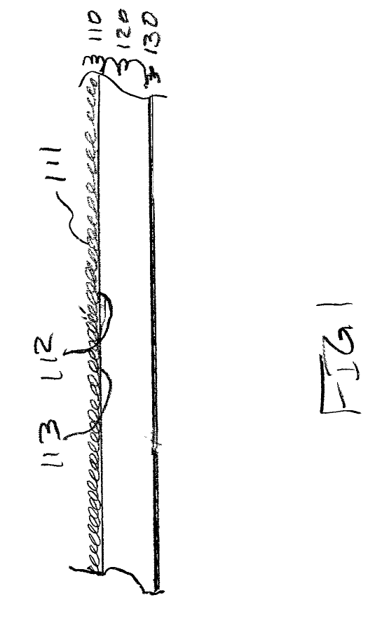

### DETAILED DESCRIPTION

Referring now to the Figures, the present invention generally relates to a foam textile lamination 100 having a base textile 110 bonded to a foam backing 120. In another embodiment, a backing material 130 is bonded to the side of the foam 120 opposite to the textile 110.

The base textile 110 has a face surface 111 and a backing surface 112. The base textile 110 can be a woven, knit, or nonwoven material. In one embodiment, the base textile 110 is a woven velour for automotive seating. The base textile 110 can be formed of synthetic or natural materials. In one embodiment, the base textile 110 includes a back coating 113 that is located on the backing surface 112 of the base textile 110 for mounting the foam backing 120. The back coating 130 can be a material such as latex.

The flammability of the base textile 110 is equal to or less than about an 81 mm burn rate according to test method ASTM D3775. The base textile 110 can be selected to have tensile and elongation properties according to ASTM D5034, of at least about 50 in at 2%, through the use of knitted textiles, elastomeric yarns, and/or other methods. The base textile 110 can be selected to have a wear rating (Tabor method) of about 3 or better according to the ASTM D3884, and a light resistance of about 3 or better according to ASTM J1885.

The foam backing 120 is mounted to the back coating 113 of the base textile 110. The foam 20 will have a flammability of SE/0. The flammability of the foam can be provided by various additives to the foam 120. In order to provide sufficient softness of the foam backing 120 for conforming to the corners of the bun, the foam backing 120 will have an indentation load deflection of about 7.2 kilograms per foot or less. In one embodiment, the foam backing 120 is selected to have an elongation of from about 200% to about 310% as measured on the instrom method. In a particular embodiment, the foam backing 120 is selected to have an elongation of about 260%, and it has a compression set at 50% compression of about 3.5. In another embodiment, the foam 120 will have a density of about 0.028 gm per cubic cm, and an air permeability of about 135 cubic centimeters per square centimeters. The foam can have a tear strength of about 4.38 lbs. per liner inch. In one example of the present invention, the foam backing 120 is a polyether polyurethane foam with a minimum thickness of about 2 mm.

In an embodiment having a backing material 130, the backing material 130 is mounted to the surface of the foam backing 120 opposite to the base textile 110. The backing material 130 can be an extruded film, point bonded polyester fabric, or circular net scrim. The backing material can be flame laminated, bonded, or the like, to the foam backing.

The composite laminate shall have a flammability according to ASTM D3775 of about 100 mm/minute or less. In one embodiment, the bond strength of the foam to the fabric shall be 3 N/25 mm according to ASTM D751, and a bond after heat aging of 3 N/25 mm or greater according to SAE J1767.

What is claimed is:

1. A composite comprising:
a base textile having a face surface and a backing surface;
a foam backing mounted to the backing surface of the base textile, the foam backing having an indentation load deflection of about 7.2 kilograms per foot or less.
